(19) United States
(12) Patent Application Publication
(10) Pub. No.: US 2003/0192530 A1
(43) Pub. Date: Oct. 16, 2003

(54) Method and apparatus for operating a gas-powered cooking and frying device

(76) Inventors: Fred Bulthaup, Kirchlengern (DE); Andreas Telkemeier, Buende (DE)

Correspondence Address: Law Offices of Karl Hormann, P.O. Box 381516, Cambridge, MA, 02238-1516, US

(21) Appl. No.: 10/413,071

(22) Filed: Apr. 14, 2003

(30) Foreign Application Priority Data
Apr. 16, 2002 (DE) 102 17 008.8

(51) Int. Cl. A47J 27/02; F23Q 3/00

(52) U.S. Cl. 126/390.1; 431/264; 431/266

(57) ABSTRACT

A method and an apparatus for operating a gas-powered cooking device including an actuator for moving a closure disposed in the gas feed conduit of a burner to an open state and of igniting gas emitted from the burner by an ignition electrode to form a burner flame, the ignition electrode being connected to an ignition voltage for a predetermined first interval of time, a sensor thermo-conductively connected to the burner flame for generating a sensor voltage for maintaining the closure means in its open state if the sensor voltage attains a predetermined level and of initiating subsequent ignitions after a predetermined interval of time where the predetermined level is not attained within a predetermined further interval of time.

### BACKGROUND OF THE INVENTION

1. Field of the Invention

The invention, in general, relates to a method and apparatus for operating a gas-powered cooking and frying device, and, more particularly, to a method and apparatus of the kind referred to provided with an actuating means for moving a closure means disposed in the gas feed of the device to an open state, with an ignition electrode for generating an ignition spark for igniting the combustible gas mixture flowing from the burner, with a control unit for electrically connecting the ignition electrode to a source of ignition voltage for a predetermined first interval of time, and with a sensor thermally conductively connected with the flame of the burner, the sensor generating an electrical sensor voltage for maintaining the closure means in its open state.

2. The Prior Art

Both a method and a device for practicing the method are well known. For instance, a method is known for operating a gas-powered cooking device in which a rotary knob provided with a keying function is used as an actuator. When actuating the keying function, a closure means structured as a magnetic insert and disposed in a gas fee of a burner is moved from a closed to an open state. This leads to the magnetic insert to be moved from a closed to an open state against the bias of a spring mounted on the magnetic insert. There is provided yet another valve in the gas feed which may be opened by rotating the rotary knob. Only after this has occurred will gas flow from the burner. At the same time, by rotating the rotary knob, a timer in a control unit will be actuated electrically to connect the ignition electrode for a predetermined first interval of time to a source of ignition voltage. The ignition electrode releases an ignition spark for igniting the gas mixture flowing from the burner. A thermo-sensor is arranged in the cooking device in thermo-coupled connection with the flame of the burner to generate an electrical sensor voltage for maintaining the magnetic insert in its open state. If the keying function is no longer actuated and if the electrical sensor voltage is insufficient, the magnetic insert is automatically returned, by the bias of the spring, to its closed state, and the gas feed to the burner is interrupted again. This may happen, for instance, if after ignition the flame of the burner has failed sufficiently to heat the thermo element or if the flame of the burner is extinguished by a draft. In that case, the ignition described about has to be carried out anew. Therefore, one disadvantage of the known method is that every time the burner flame is extinguished the feed of gas is interrupted by the magnetic insert, and renewed manual ignition is necessary.

### OBJECT OF THE INVENTION

Therefore, it is an object of the invention to provide a method of operating a gas-powered cooking or frying device by which following a first manual ignition renewed ignition is performed automatically in case the burner flame has been extinguished.

### SUMMARY OF THE INVENTION

This and other objects of the invention are accomplished in a method and device of the kind referred to above, by additionally processing an electrical sensor voltage generated by a sensor in a first evaluation circuit of a control unit such that upon attaining a switching condition depending upon the course of the electric sensor voltage the ignition electrode is again electrically connected with the ignition voltage.

For practicing the method in accordance with the invention, there is provided a device of the kind set forth supra provided with a first evaluation circuit in a control unit for additionally processing the electric sensor voltage electrically to connect the ignition electrode to the source of ignition voltage upon reaching a switching state depending upon the course of the sensor voltage.

In addition to the automatic re-ignition after extinction of the burner flame and the operational ease for a user, the advantages derived from the invention are, in particular, that the sensor, which in the known method serves the sole function of generating, at an existing burner flame, a sufficiently high electric sensor voltage for maintaining a closure means in its open state to prevent interruption of gas feed to the burner during operation of the cooking device, additionally functions electrically to connecting the ignition electrode to the source of ignition voltage in dependence of the electric sensor voltage. While it is known instead of the safety arrangement described above, i.e. to return of the closure means to its closed state in case the thermo-element fails to generate a sufficiently high electric sensor voltage, to use an ignition electrode for additionally sensitizing the ionization of air and for initiating a re-ignition in response to this signal. However, a disadvantage of such an arrangement is that in case of an electric power failure no re-ignition can take place, and gas will continue to flow from the burner with a potentially explosive mixture developing in the room in which the cooking and frying device is installed.

In an advantageous further embodiment of the invention an electric signal is fed from the actuating means to the control unit to be processed in a second evaluation circuit of the control unit for maintaining the closure means, by the second evaluation, in its open state for a predetermined second interval of time depending upon the electric signal. This further improves the ease of operation for a user as a single and short-time actuation of the actuation means during an ignition operation is sufficient. Hence, actuation of the actuation means up to the point in time at which the closure means is maintained in its open state by the electric sensor voltage is no longer necessary.

A further advantageous embodiment provides for the closure means being maintained in its open state for a second interval of time by an electric holding voltage generated by the control unit and for processing the second interval of time by a safety means separate from the control unit and for electrically separating, upon expiration of the second interval of time, the electric holding voltage from the closure means for an indefinite third interval of time. The safety of the method is thus improved further as upon expiration of the second interval of time the closure means is disconnected from the holding voltage independently of the control unit so that during the third interval of time the closure means is maintained in its open state solely by a sufficiently high electric sensor voltage.

A particularly advantageous embodiment of the invention provides for the first evaluation circuit of the control unit processing the change over time of the electric sensor voltage. On the one hand, extinction of the burner flame may thus be detected in advance and on the other hand, unnecessary re-ignition may be substantially prevented.

In a further embodiment of the invention, the closure means is moved to its open state and the electric signal is simultaneously fed to the control unit by the actuating means. This provides for improved ease of operation to a consumer.

In principle, kind, size, material and number of the actuation means may be selected from a wide variety. As a matter of efficiency, the actuating means is structured as a rotating dial with an integrated keying function. A touch screen is a particularly efficient and useful actuating means.

In a particularly advantageous embodiment of the invention the closure means is provided with a magnetic insert provided with a spring the bias of which counteracts the magnetic force generated by the electric sensor voltage or electric holding voltage and returns the magnetic insert to its closed state. In this manner, the closure means is returned to its closed state whenever the electric sensor voltage or the electric holding voltage is insufficiently high to maintain the closure means in its open state.

In a further advantageous embodiment of the invention the control unit is provided with a micro-processor with the first and/or the second evaluation circuit being an integrated circuit of the micro-processor. Micro-processor are advantageous and efficient components requiring little space.

In a further advantageous embodiment the safety element is structured as a safety circuit, since circuits are cost-efficient and require little space.

A particularly advantageous embodiment provides for the sensor being a thermo-element in view of the fact that thermo-elements are cost-efficient standard components.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 is a block circuit diagram of the device for practicing the method of the invention; and

FIG. 2 is a graph exemplarily depicting the course over time of the electric sensor voltage.

### DETAILED DESCRIPTION OF THE PREFERRED EMBODIMENT

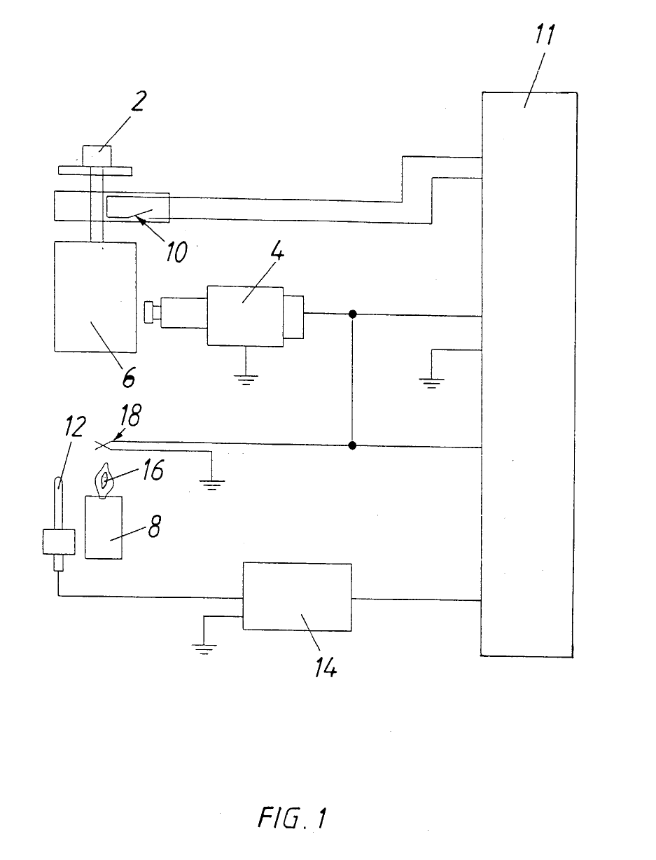

FIG. 1 depicts an embodiment of the device for practicing the method in accordance with the invention. The cooking device, which is shown only partially, is provided with actuating means 2 structured as a rotary selection switch with an integrated keying function. The actuating means 2 cooperates mechanically with closure means 4 structured as a magnetic insert. In a state not shown, the closure means 4 blocks the flow path of a gas feed conduit 6 to a burner 8 and in its shown open state it does not block the flow bath. The magnetic insert 4 is provided with a spring (not shown) which biases the magnetic insert 4 in the direction of the closed state. The actuating means 2 is mechanically connected with a valve 9 (not shown) disposed in the gas feed conduit 6. Further more, a main switch 10 may be actuated by the actuating means 2. The main switch 10 is disposed in a first circuit which electrically connected to a micro-processor functioning as a control unit 11. An ignition electrode 12 is arranged in spatial proximity to the burner 8. Moreover, the ignition electrode 12, an ignition relay (not shown) and a source of ignition voltage 14 are arranged in an ignition circuit (also not shown). The ignition relay is actuated by the control unit 11. In spatial proximity and in a heat-transfer connection with the flame 16 of the burner 8 there is arranged a sensor 18 structured as a thermo-element. The thermo-element 18 is electrically connected to the magnetic insert 4 and with a first evaluation circuit (not shown) of the control unit 11. The magnetic insert 4, a holding voltage relay (not shown) and an electric holding voltage generated by the control unit 11 are arranged in a holding voltage circuit also not shown. The holding voltage relay may be actuated by the control unit 11.

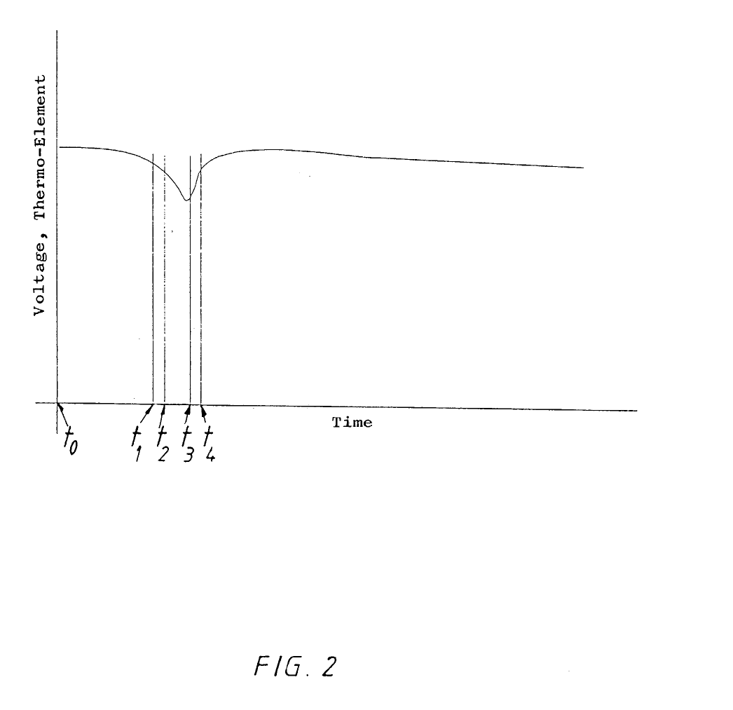

Hereafter, the function of the method of the invention and of the embodiment of the device for practicing the method will be explained with reference to FIGS. 1 and 2.

The cooking device in accordance with the invention is connected to electric mains. By actuating the keying function of the actuating means 2 the magnetic insert 4 is mechanically moved to its open state (FIG. 1) against the bias of the spring connected to the magnetic insert 4. The valve in the gas feed conduit 6 is opened by rotating the actuating means 2 in a counterclockwise direction. The flow path in the gas feed conduit 6 towards the burner 8 is thus open, and gas will be emitted by the burner 8. At the same time as the keying function of the actuating means 2 is actuated, the main switch 10 in the first control circuit is closed, and an electric signal is fed to the control unit 11. This causes a first timing member in control unit 11 and the ignition relay to be actuated to connect the ignition electrode 12 for a predetermined interval of time to the ignition voltage 14. The ignition electrode 12 thus generates ignition sparks for igniting the gas emitting from the burner 8 and generating flame 16 of the burner 8. Upon expiration of the first interval of time, the ignition relay will again open the ignition circuit. Also, a second time member (not shown) in the control unit 11 and the holding voltage relay are actuated so that the magnetic insert 4 is electrically connected to the holding voltage for a predetermined second interval of time so that the magnetic insert 4 is maintained in its open state. Thus, only a single and short-time actuation of the keying function of the actuating means 2 is required. The thermo-element 18 is heated and the electric sensor voltage is generated by the flame 16 of the burner 8. Upon expiry of the second interval of time, the holding voltage relay again opens the holding voltage circuit. Provided the electric sensor voltage has reached a sufficiently high value, the magnetic insert 4 will be maintained in its open state by the electric sensor voltage, even after expiry of the second interval of time, so that the electric holding voltage is no longer required.

If the burner flame 16 is extinguished at this time, for instance by a draft of air, the electric sensor voltage at the first evaluation circuit of the control unit 11 is changed. In the present example, the evaluation circuit processes the change over time of the electric sensor voltage (see FIG. 2). FIG. 2 qualitatively depicts an exemplary course over time of the electric sensor voltage. The value of the electric sensor voltage is depicted on the ordinate; the abscissa identifies the time t. The course shown in FIG. 2 corresponds, from time t₀ to time t₁, to the course of the electric sensor voltage of the thermo-element 16 at a switched on cooking device and ignited burner flame 16. It is to be noted that the values shown in the graph are average values since the electric sensor voltage fluctuates within certain limits even during normal operation of the burner 8. There is a drop in the electric sensor value in the interval of time from t₁ to t₂. The first evaluation circuit compares the voltage drop measured in the interval of time t₁ to t₂ against a predetermined temporal course of the voltage drop which coincides with the extinction of the burner flame 16. The voltage drop of the example of FIG. 2 corresponds to the predetermined temporal course of the voltage drop, and the ignition relay is again actuated by the first evaluation circuit of the control unit 11. The ignition circuit is thus closed and the ignition electrode 12 is again connected to the ignition voltage 14 to generate ignition sparks for igniting the burner flame 16 again. In the mean time, time t₃ has been reached (see FIG. 2). Analogous to the voltage drop, the first evaluation circuit compares the rise in voltage measured during time interval t₃ to t₄ against a predetermined temporal course of the rise in voltage. The rise in voltage of the example of FIG. 2 corresponds to the predetermined temporal course of the rise in voltage, and the ignition relay is actuated by the first evaluation circuit of the control unit 11 such that the ignition circuit is opened and the ignition electrode 12 is disconnected from the ignition voltage 14. Upon reaching time t₄ the voltage course will have reached the average value characteristic of normal operation of the burner 8. The evaluation circuit is structured such that a drop in the voltage of the sensor voltage caused by normal operation of the cooking device, for instance by reducing the gas feed by rotation of the actuating means 2 in a counter-clockwise direction, does not result in re-ignition as described above. This may be achieved by utilizing the temporal change in electric sensor voltage which during an intended reduction of the gas flow drops more slowly than it would with an undesired extinction of the burner flame 16.

The described embodiment is additionally provided with a safety circuit (not shown) which constitutes a safety device electrically connected to the control unit 11. The safety circuit includes third and fourth timing members and a safety relay. The safety relay opens the holding voltage circuit in response to a signal from the third timing member. The third timing member is actuated after the holding voltage relay has been closed in the manner described supra. Upon expiry of the predetermined second interval of time the safety relay is actuated by the third timing member to open the holding voltage circuit. At the same time the fourth timing member is actuated for clocking a predetermined third interval of time. During the third interval of time the magnetic insert 4 is disconnected from the electrical holding voltage, independent of the control unit 11. Provided the electric sensor voltage generated by the thermo-element 18 is sufficiently high to maintain the magnetic insert 4 in its open state, the flow path in the gas feed duct 6 remains unimpeded. This is the case as long as the burner flame 16 remains burning. In the present situation, if the burner flame 16 has been extinguished for any reason, the electrical sensor voltage will not be sufficiently high to maintain the magnetic insert 4 in its open state against the bias of its integrated spring. Upon expiry of the third interval of time the safety relay will therefore be actuated again to close the holding voltage circuit. Since the holding voltage relay is otherwise actuated in this manner only for purposes of a first manually initiated ignition during the predetermined second interval of time, the holding voltage circuit remains open until a renewed manually initiated initial ignition.

What is claimed is:

1. Apparatus for operating a gas-powered cooking device, comprising:
actuating means for moving closure means disposed in a gas feed conduit of a burner to an open state;
an ignition electrode for generating an ignition spark for igniting a combustible gas mixture emitted by the burner to form a burner flame;
a sensor connected to the burner flame by heat conductance for generating an electric sensor voltage over a predetermined temporal course to maintain the closure means in the open state thereof;
a control unit for electrically connecting the ignition electrode to an ignition voltage for a predetermined first interval of time and provided with a first evaluation circuit for processing the sensor voltage to connect the ignition electrode to the ignition voltage in a response to a switching state dependent on the temporal course of the electric sensor voltage.

2. The apparatus of claim 1, wherein the actuating means is provided with means for substantially simultaneously moving the closure means to it open state and feeding an electric signal to the control unit.

3. The apparatus of claim 2, wherein the actuating means comprises a rotary selection know with an integrated keying function.

4. The apparatus of claim 2, wherein the actuating means comprises a touch screen.

5. The apparatus of claim 2, wherein the closure means comprises a magnetic insert provided with a spring for biasing the magnetic insert against the force generated by the sensor voltage to the closed state of the closure means.

6. The apparatus of claim 1, wherein the control unit comprises a microprocessor and wherein the evaluation circuit is integrated in the micro-processor.

7. The apparatus of claim 1, further comprising a safety means constituted as a safety circuit.

8. The apparatus of claim 1, wherein the sensor comprises a thermo-element.

9. A method of operating a gas-powered cooking device, comprising the steps of:
moving an actuating means to move a closure means disposed in the gas feed conduit of a burner to an open state to cause gas to flow from the burner;
electrically connecting an ignition electrode to an ignition voltage for a predetermined first interval of time to generate an ignition spark for igniting gas flowing from the burner and forming a burner flame;
thermo-conductively exposing a sensor to the burner flame for generating a sensor voltage over a predetermined course for maintaining the closure means in its open state;
processing the sensor voltage in a first evaluation circuit of a control unit for electrically connecting the ignition electrode to the ignition voltage in response to a switching state dependent upon the course of the sensor voltage.

10. The method of claim 1, further comprising the step of causing the actuating means to feed an electric signal to the control unit for processing in a second evaluation circuit and of maintaining the closure means in its open state for a predetermined second interval of time depending upon the electric signal.

11. The method of claim 10, further comprising the step of the control unit generating a holding voltage for maintaining the closure means in its open state for a predetermined second interval of time and processing the second interval of time by safety means independent of the control unit and upon expiry of the second interval of time of electrically disconnecting the holding voltage from the closure means for a predetermined third interval of time.

12. The method of claim 9, further including the step of the first evaluation circuit processing temporal changes in the electric sensor voltage.
